(19) United States
(12) Patent Application Publication
(10) Pub. No.: US 2003/0209159 A1
(43) Pub. Date: Nov. 13, 2003

(54) Bladder with a constant contact region for cleaning a blanket cylinder

(76) Inventors: Avi-Ben Porat, Norwalk, CT (US); Vladimir Ilic, Milford, CT (US); John Marganski, Ansonia, CT (US)

Correspondence Address: MORGAN & FINNEGAN, L.L.P., 345 Park Avenue, New York, NY, 10154-0053, US

(21) Appl. No.: 10/141,796

(22) Filed: May 8, 2002

(51) Int. Cl. B41F 35/00; B41L 41/00

(52) U.S. Cl. 101/425

(57) ABSTRACT

A bladder for bringing and engaging a cleaning cloth into contact with a blanket cylinder. The bladder has a molded (extruded or machined) shape optimized to, when inflated, provide a contact surface elevated above the remainder of the bladder. When the bladder is not inflated, the central portion is elevated above the remainder. In addition, the device has improved contact characteristics, providing significant improvement in the consistency of contact surface with less sensitivity to pressure fluctuations between the cylinder and the bladder over prior art.

### FIELD OF THE INVENTION

An improved system and method for cleaning a blanket cylinder; more particularly, a consistent way of maintaining contact between a cleaning cloth and a blanket cylinder in an automatic blanket cylinder cleaner having a bladder.

### DESCRIPTION OF RELATED ART

This invention relates to a device for automatically removing ink, contaminants, and debris that collect on the blanket cylinder as well as plate cylinder or impression cylinder of an offset lithographic printing press during the printing process. In order to maintain high print quality, it is necessary to periodically clean and condition the blanket cylinder of a printing press. Since the cleaning process necessarily results in press “down time,” it is highly desirable that effective cleaning of the blanket cylinder take place in the minimum time possible.

There are several methods of cleaning the blanket cylinder of a printing press. One method uses a mechanical device to bring a blade or brush into contact with the blanket cylinder. This method is not preferred because the device that moves the cleaning surface occupies significant space in a cramped printing press.

Another cleaning system uses a cleaning surface that pushes a cleaning cloth or fabric onto the blanket cylinder. In conjunction with cleaning solvents sprayed onto the cleaning cloth, the mechanical cleaning surface removes debris from the blanket cylinder. A system of this type is disclosed in U.S. Pat. No. 4,344,361 issued to J. MacPhee et al on Aug. 17, 1982.

The cloth used in the blanket cleaning operation should have certain qualities, i.e.; it should be absorbent to both water and solvent and be uniform in its absorbency. In other words, the cloth should not have openings or apertures such as found in a lattice type weave. The cloth should have sufficient abrasion resistance so as not to shed lint or other particles which produce what are known in the trade as “hickeys.” The cloth must also have mechanical strength to avoid breakage and be soft enough so as not to scratch the blanket cylinder.

The use of a flexible bladder offers several advantages over other types of mechanical cleaning means. The use of the bladder as a mechanical scrubbing means can be used for a large number of different types and sizes of presses. The use of the bladder instead of a roller, brush, or sponge, for example, permits the construction of a more compact device. The bladder may be engaged pneumatically, through inflation of a chamber beneath the aforementioned bladder, or may be brought into engagement by mechanical positioning means.

A system is provided for advancing the cloth over the blanket cylinder in an optimum manner. It has been found that the amount of cloth needed to clean the blanket cylinder is dependent upon the manner in which the advancement of the cloth is synchronized with the rotation of the blanket cylinder. Incrementally advancing the cleaning cloth in a simple and economic manner is preferred. An advancing means advances the cleaning cloth independently of the amount of cloth on the supply and take-up rolls and minimizes the possibility of the cleaning cloth being drawn into the press and wrapped around press rollers or cylinders. Either the cleaning cloth may be moved while the bladder is engaged, or the bladder may be moved out of position, the cloth moved, and then the bladder again engaged.

The primary disadvantage to the blanket cylinder cleaning apparatus using inflation means to move the bladder is the significant fluctuation of bladder height corresponding to relatively small changes in air or hydraulic pressure. The contact surface (specifically the bladder) in the prior art embodiment is subject to fluctuations of as much as one eighth of an inch (⅛″) per 1 psi variation of air pressure and thus changes the nip contour and width. This can cause a serious decrease in cleaning quality for a system operating at significant pressure (as the pressure is adjusted upward in order to obtain the correct nip size). In order to overcome this limitation, prior efforts have required that additional cleaning cloth and solvent be used, resulting in increased downtime and material costs. Even in systems that are not engaged using air pressure, conventional bladders fall short of desired results, as pressures on the bladder often results in a smaller than desired contact region.

Another disadvantage of this type of cleaning apparatus is the bladder must be affixed to the manifold so as to prevent leakage of the inflation means, typically necessitating a silicon or the like sealing agent be used to ensure a reliable seal. Thus, there is a need to provide a consistent way of maintaining contact between a cleaning cloth and a blanket cylinder in an automatic blanket cylinder cleaner having a bladder.

### SUMMARY OF THE INVENTION

The bladder specified in this disclosure provides a surface to contact the cleaning cloth, which together will be engaged to the blanket cylinder, and in so doing assures consistent contact with the blanket cylinder despite fluctuations in the inflation mechanism. The invention is a formed inflatable bladder, functioning as a single piece, to be mounted on means to engage the bladder to the blanket cylinder as part of the cleaning apparatus. The surface of the bladder has a longitudinally symmetric shape in which a central elevated region provides contact the cleaning surface of the device, the bladder extends the length of the blanket cylinder. The central portion is elevated above the edges of the bladder.

In one embodiment, a flange/clamp design to secure the bladder to the manifold. Another embodiment of this disclosure uses screws for securing the bladder to the manifold.

By providing more consistent contact between the cleaning cloth and the blanket cylinder as well as a plate cylinder or an impression cylinder, this invention provides more predictable usage of cleaning cloth and solvent, resulting in lower cost, reduced waste, and more accurate estimation of cleaning products required. The bladder also decreases the need for fine adjustments of the cleaning apparatus. Significant benefit can be derived from the subject of this disclosure in an embodiment having mechanical means to move the bladder.

### BRIEF DESCRIPTION OF THE DRAWINGS

FIG. 1 is a perspective view of the blanket cylinder, plate cylinder, or impression cylinder and the blanket cylinder, plate cylinder, or impression cylinder cleaning device.

FIG. 2 is a vertical section showing the bladder not inflated and the cleaning cloth spaced away from the blanket cylinder.

FIG. 3 is a vertical section showing the bladder inflated and the cleaning cloth contacting the blanket cylinder, plate cylinder, or impression cylinder.

FIG. 4 is a detail cross-section of the mounting region of the manifold.

FIG. 5 is a manufacturing diagram of the mold used to create one embodiment of the bladder.

FIG. 6 is a top down view of the mold used to create one embodiment of the bladder.

FIG. 7 is a vertical section view of the bladder, and the bladder coupled to the manifold via flange/clamp design.

FIG. 8 is a perspective showing the new bladder, and the new bladder coupled to the manifold via flanges/clamp design.

### DETAILED DESCRIPTION

Flexible bladders have been demonstrated to provide advantages over other currently available types of devices to clean blanket cylinders. For example, in U.S. Pat. No. 4,757,763 to MacPhee et al, a flexible bladder is inflated in order to bring a cleaning cloth into contact with a blanket cylinder in a printing press. This flexible bladder provides a semi-rigid surface that presses a cleaning cloth, doused with solvents, against the blanket cylinder to clean said blanket cylinder.

Inconsistency of nip surface contact between the blanket cylinder, plate cylinder or impression cylinder and the flexible bladder is the primary limitation of the system taught by the MacPhee, and in link systems. The cleaning system is dependent on consistent contact between the blanket cylinder and the flexible bladder for the duration of the cleaning cycle, but fluctuations of the air pressure actuating the system can cause significant changes in the contact surface of the flexible bladder. These variations of the flexible bladder cause an incomplete cleaning cycle, where parts of the cylinder may not make full contact, or make inconsistent contact with the cleaning cloth during the process.

An improperly completed cleaning cycle can result in the need to repeat the cleaning cycle. This causes:

a) additional downtime from repeated cleaning operations,

b) additional downtime from frequent cleaning cloth replacement,

c) cost incurred for use of additional cleaning cloth,

d) cost incurred for use of solvent, or

e) cost incurred from need to wash or touch up in manual operation

The subject of the present disclosure solves the problems related to the current state of the art flexible bladders by offering a unique geometry of an inflatable bladder. The inflatable bladder disclosed offers significant advantages over the prior art by providing a region that remains in constant contact with the blanket cylinder, plate cylinder or impression cylinder during the cleaning cycle, regardless of variation within the inflation means.

The geometry of the present disclosure creates a region that does not changes its contour or deform when subjected to significant changes in the pressure to which it is subjected. The flexible bladder taught by the MacPhee patent is substantially flat. The inflatable bladder disclosed has a central region that remains flat and does not deform (but slightly, in order to conform with the cylinder's curvature at the contact surface) when the bladder is inflated, or when pressure varies once the bladder is inflated. The inflatable bladder has an elevated portion that is held up by a region that has curvilinear segments designed to have no points that act as stress concentrators.

The inflatable bladder arrangement discussed has a central elevated portion can freely move up and down, but is constrained in such a way that it does not deform and remains flat or will conform to the contact surface. This relative inflexibility makes the elevated portion a consistent surface with which to bring the cleaning cloth into contact with the blanket cylinder.

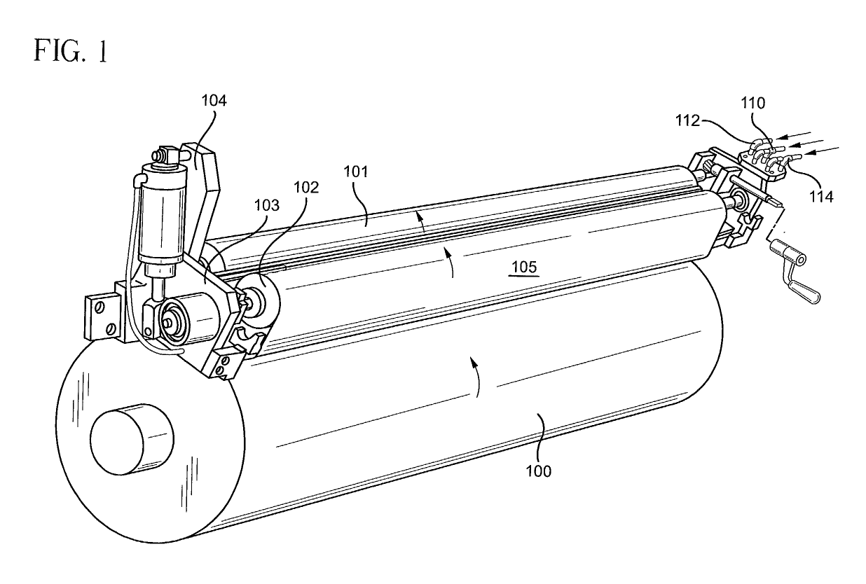

FIG. 1 shows a device for cleaning a blanket cylinder, plate cylinder or impression cylinder, in a printing press, but not necessarily limited to a printing press. It is understood that the term “blanket cylinder” as set forth in this description may also refer to plate cylinder, impression cylinder or the like. A frame 103 is mounted adjacent to the blanket cylinder 100. On the frame rests a cleaning cloth supply roll 101 and a used cleaning cloth take-up roll 102, both parallel to the blanket cylinder. A cleaning cloth 105 is wound around the cleaning cloth supply roll and traverses to the cleaning cloth take-up roll. The cleaning cloth is situated to pass between the two rolls on the side facing the blanket cylinder. Means to regulate the motion of the cleaning cloth 104 is connected to the cleaning cloth take up roll.

Means 104 connected to the cloth take-up roll is required for intermittently advancing the cloth onto the take-up roll. This means includes means in contact with the cloth on the cloth take-up roll or the used roll and which controls the amount of cloth being fed so that substantially the same amount of cloth is fed during each cloth advance regardless of the amount of cloth on the take-up or used roll. The system further includes means for controlling the operation of the cleaning device either automatically or manually.

When the blanket cylinder cleaning apparatus is engaged, the means to regulate the motion of the cleaning cloth take up roll cause the cleaning cloth to advance a uniform distance as a function of its diameter, regardless of how much cloth is on either roll. The blanket cylinder travels across the stationary cleaning cloth, being held in contact by the bladder. The cleaning cloth is brought into contact with the blanket cylinder, water and solvents are present or applied, and the cylinder is thus cleaned. The used cleaning cloth is advanced during the cleaning process, either in situ or by disengaging the bladder before advancing, then moving the bladder back into place.

Alternatives to this approach are understood, such as replacing the cleaning cloth supply roll with a folded cleaning cloth in a box being removed by the cleaning cloth take up roll. The means to advance the cleaning cloth a uniform distance can be implemented in any number of ways, including hand-turning the cleaning cloth take-up roll.

Another embodiment for using a well known system is to have the cloth treated prior to purchase, or on site prior to or during the cleaning process.

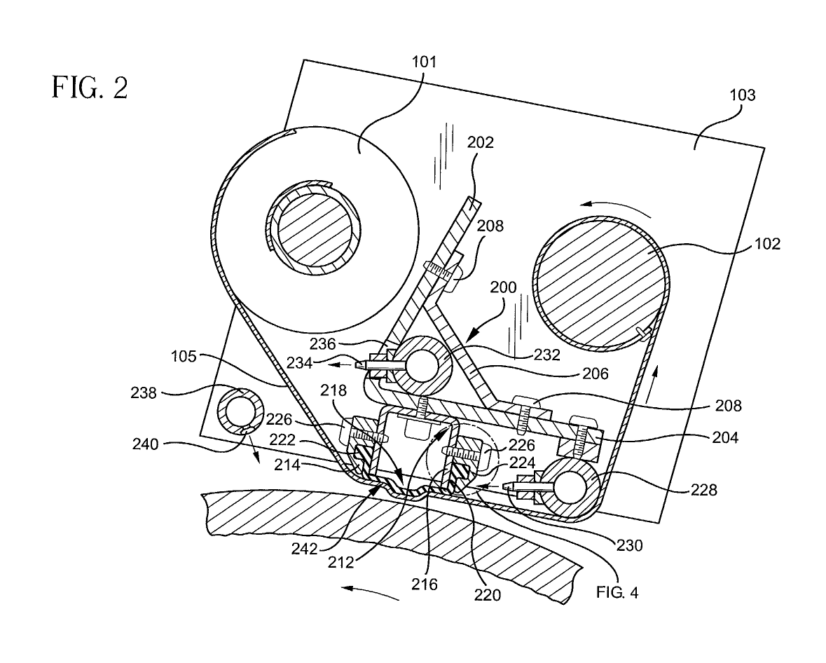

In FIG. 2, between the side of frame 103 is an essentially L-shaped support member 200 positioned generally in the center of the blanket cylinder 100, the cloth take up roll 102, and the cloth supply roll 101. The L-Shaped support member includes a generally vertically disposed leg 202 and a generally horizontally disposed leg 204. Extending between the legs is a brace member 206, which is suitably attached to legs 202 and 204 such as by screw means 208. Said brace member gives the support member 200 rigidity and strength. The support member is attached to the sides of frame 103 in any convenient manner.

Attached to the bottom surface of the generally horizontal leg 204 of the support member by any suitable means, for example screw means 210, is a manifold member 212. Said manifold can be solid, U-shaped, or any other convenient arrangement. Attached to the legs 214 and 216 of the U-shaped manifold is an inflatable bladder 218 of rubber or the like. Mounting portions 220 of the bladder are affixed to the manifold. In one embodiment the mounting portions have substantially rectangular flange members 222 which are held by clamps 224 affixed to the manifold in any convenient manner, such as screw means 226. The manifold and the bladder, it is understood, extend the length of the blanket cylinder and between the ends of frame 103.

The manifold is situated so that the bladder can expand in the direction of the blanket cylinder. The entire support member is situated to cause the bladder to touch the blanket cylinder during the cleaning cycle, but not to interfere during normal press operation. The manifold is connected in any convenient manner to a supply of compressed air that will cause the bladder to inflate.

In one embodiment, there are three tubular members affixed to the support member 103 and extending parallel to the blanket cylinder. There is a first tubular member 228 having a plurality of openings or jets 230 along the length of said tubular member. Said tubular member is connected at one end to a water supply means, which can be typical factory water. As shown, the outer surface of said tubular member serves as a guide for the cleaning cloth prior to being wound on the cloth take up roll. The jets 230 of said tubular member are directed toward the point of contact between the cleaning cloth and the blanket cylinder.

In the case that the cloth is not saturated with solvent, a second tubular member 232 is positioned between the legs of the L-shaped support member and has a plurality of jets 234 which extend through openings 236 extending along the length of said support member. This second tubular member is connected to a supply of non-aqueous solvent, such as hydrocarbon solvent or other ink or debris specific cleaning solvent by a conduit means. The jets 234 of said tubular member are directed toward a region of the cleaning cloth that has yet to pass over the bladder.

It can be envisioned that one of the tubular members can be utilized for multi liquid spray (supply), solvent and water for example. However, those tubes and spray nozzles are not always required (only in certain conditions).

There is a third tubular member 238 having a plurality of jets or openings 240 positioned along the length of said tubular member. The jets or openings are directed towards the surface of the blanket cylinder so as to dry the water or solvent remaining on the blanket after the cloth has been retracted. This tubular member is located at the trailing edge of the cleaning cloth and so is the last part of the cleaning process to interact with the blanket cylinder.

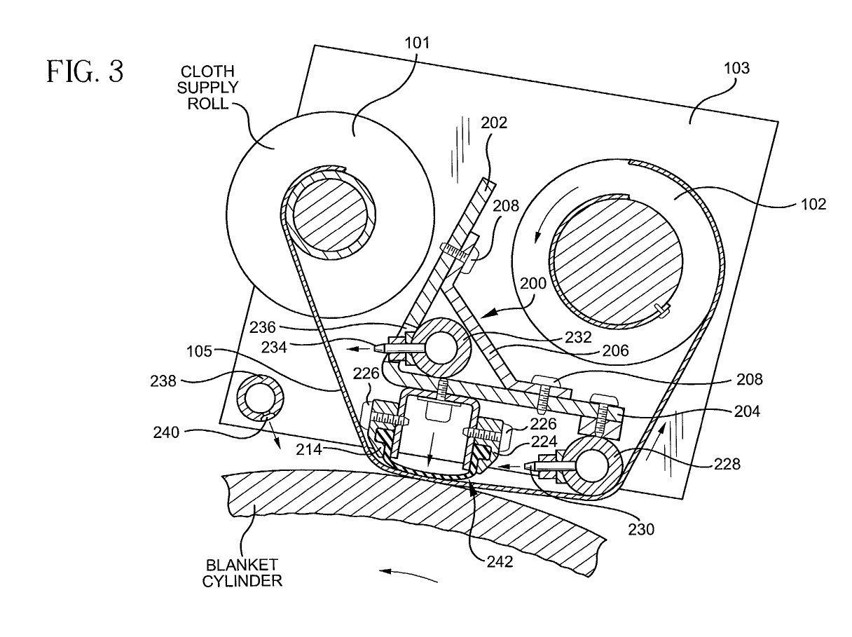

As can be seen from a comparison of FIG. 2 and FIG. 3, by filling the manifold with fluid under pressure, the lower surface 242 of the bladder will move from the inoperative position of FIG. 2 to the operative position of FIG. 3 where the cloth 105 has been moved into engagement with the surface of the blanket cylinder to thereby clean the same. This is done in a sequentially controlled manner.

The cleaning process begins when the bladder inflates to bring the cleaning cloth into contact with the blanket cylinder. The means 104 regulating the cleaning cloth movement engage, and begin drawing the cleaning cloth across the surface of the blanket cylinder. As the cloth moves, the cleaning solution begins being application from the tubular members; the water supply tubular member 228 begins releasing water onto the cleaning cloth and the solvent supply tubular member 232 begins releasing solvent onto the cleaning cloth. The bladder rubbing the surface of the blanket cylinder with the treated cleaning cloth produce the desired effect of cleaning the blanket cylinder. Simultaneously, the tubular member attached to an air supply begins air drying the blanket cylinder as it emerges from under the cleaning cloth. Nevertheless, that drying operation of the cylinder can be, and mostly is, done at the end of the cleaning cycle.

Tubular members are not necessary for press operation, and may be eliminated or replaced with a single device to guide the cleaning cloth onto the cleaning cloth take-up roll used in conjunction with a plurality of independent tubes to deliver the cleaning solvent, water, and drying pressure to the blanket cylinder. In addition, a cloth previously saturated with solvent removes the need for this solvent application.

That compressed air supply is typically found in factories is a matter of course, but the use of other fluid inflation media is understood. There are a plurality of other embodiments for the specific implementation of the cylinder cleaning apparatus. In one embodiment, the cloth on the supply roll may have been previously treated with necessary cleaning solvents, whether on the press site or prior to purchase. The solvent may also be applied on the press prior to unwinding the supply roll, at some point between the supply roll and the bladder, or adjacent to the bladder itself, as in the aforementioned embodiment. Other possible embodiments have no drying means, or some other means to dry the cylinder.

The manifold need not be a “U” channel, but instead may be just a small gap between a bar and the bladder, sufficient only for inflation. Further, the bladder may be mounted on a device for mechanically engaging the cleaning cloth to the cylinder.

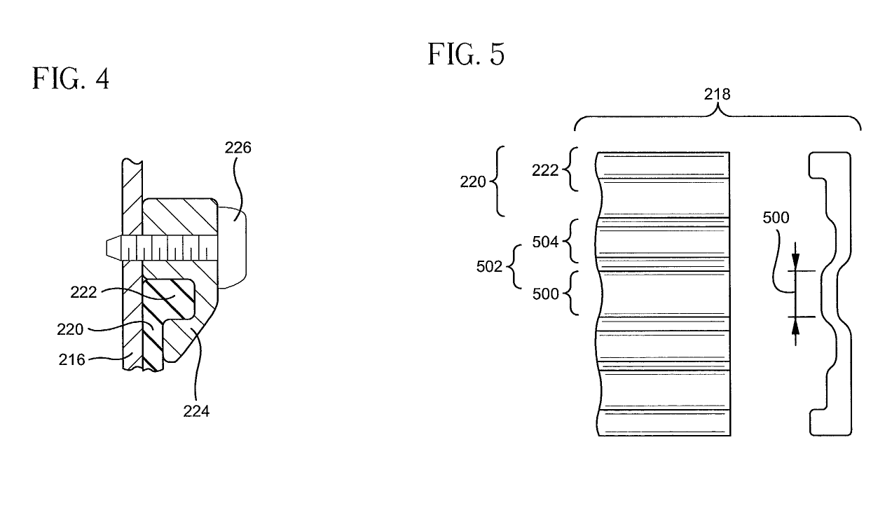

FIG. 4 shows a detail of the mounting portion 220 of the bladder affixed to the manifold wall 216. The mounting portion is characterized by having a substantially rectangular flange member. This flange is held by means of a clamp 224 that is mounted to the manifold by some convenient means, such as screw means 226. The clamp/flange arrangement substantially reduces the need for sealant between the manifold and the bladder because the molded shape is less subject to deformation than a plain rubber bladder.

The flange/clamp arrangement of securing the bladder to the manifold is one of several possible means to affix the bladder to the manifold. Other possibilities include using a bladder with flat mounting portions and using a sealant and screws to bind the bladder between the manifold and a gasket.

Other embodiments of this mounting means are possible, with the understanding that a method that reduces need to alter or machine the bladder following its manufacture is preferred.

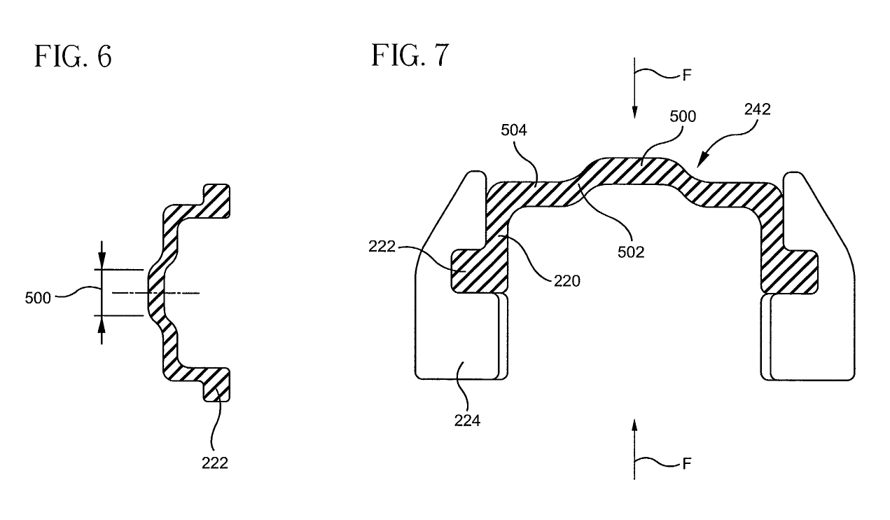

The bladder 218 in FIG. 2 and FIG. 5 and bladder 242 in FIG. 6 is molded to form a specialized shape that permits continued contact with the blanket cylinder during the cleaning process despite fluctuations in pressure within the manifold. One embodiment of the bladder in its unattached form is shown in FIG. 5 and FIG. 6. This longitudinally symmetric bladder has a central portion 500 that is elevated by arcuate portions 502. Connecting to the arcuate portions are flat or slightly arcuate (if the geometry requires so) portions 504, which serve to move the bladder toward the blanket cylinder by expanding during inflation. The flat portions are connected to mounting portions 220 that connect to the sides of the manifold. When straight blotter material installed, the bladder is folded to be a U-shaped device in FIG. 7.

Depicted with clamps 224 in place, the characteristics of the bladder are more obvious. There is a central portion 500, elevated with respect to the other parts of the bladder. The central portion is elevated by an arcuate region 502. The bladder is attached to the manifold by mounting portions 220 that attach to flat portions 504, which lead to the arcuate portions. When the bladder is inflated, the mounting portions are stretched, as are the flat portions. The flat portions expand away from the manifold, bringing the arcuate portions up as well. The arcuate portions have no concentrators of stress, and as such deform in such a way as to hold the central portion constant. The central portion is not the subject of deformation, but can freely move up and down as the flat and arcuate portions flex. The central portion can also slightly arc to conform to the cylindrical surface, which need to be cleaned.

By having a central portion held at constant surface area, the central portion acts as a rubber pad being brought into contact with the blanket cylinder. This pad approach combines the preferred element of the pneumatic cleaning system configuration, small size, with the preferred element of larger, mechanical cleaning system configurations, consistency of contact.

The flat portions, arcuate portion, and the central elevated portion all rest over the open end of the manifold, while the mounting portion affixes to the side of the manifold. Other embodiments are possible, and the bladder can be composed in any arrangement that has a portion elevated.

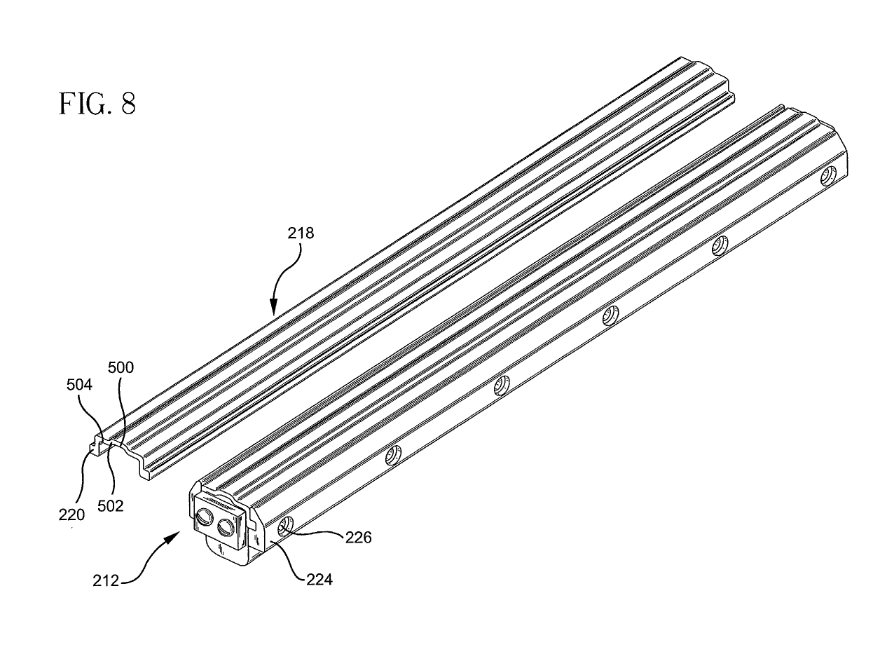

A further view of the bladder is depicted in FIG. 8. This shows the bladder, mounted on a manifold and secured via clamps. In this perspective view, the symmetric arrangement of the bladder is shown.

The bladder described is affixed to the cleaning apparatus. This may be done a using screws, through clamps 224 affixed to the manifold holding flanges 222 formed into the bladder, or by some other means.

The central portion 500 of the bladder serves as the contact surface for the blanket cylinder. The bladder design gives the elevated portion sufficient contact area with the blanket cylinder as to minimize the effects of fluctuations within the manifold. The central portion of the bladder is the surface that will be engaged with and will make contact with the cleaning cloth. It can be seen that the top of the bladder is substantially flat, with sections of differing height. In this embodiment, the bladder is longitudinally symmetric and has three paired regions, and one central region of a bladder that functions as a single unit.

The inflatable bladder functions as a unitary object that has multiple areas. The bladder is constructed of uniform thickness and density, and is composed of a uniform material. In one embodiment, the bladder is constructed from several pieces put together with adhesive.

Other configurations of bladders are understood, from this disclosure, to include any configuration where a bladder is installed to have a portion elevated over the other parts of the bladder not used for mounting. Further advantage is to be gained by using radial edges on each corner of the bladder, and between regions, such as the boundary between the region elevating the central region and the central region itself. In this way, stress at corners is minimized making the product more durable. In addition, formation of the bladder is easier without corners, this is understood in the art.

One embodiment of the bladder is formed by two mounting portions joined by arcuate portions that serve to elevate the central portion of the bladder.

Cleaning operation involves the inflation of the bladder by air pressure or some other means. In one embodiment, the bladder is moved into position by a mechanical means. Once the bladder is inflated and is in consistent contact with the blanket cylinder, plate cylinder or impression cylinder, the blanket cylinder begins moving. The cleaning cloth can be advanced ill slowly, or incrementally by deflating the bladder during its motion. The solvents, combined with the mechanical rubbing caused by contact with the inflatable bladder, clean the blanket cylinder. After the cleaning cloth has passed over the surface of the blanket cylinder a series of air jets may dry the blanket cylinder.

Following the cleaning of the entire blanket cylinder, the inflatable bladder is deflated, causing the cleaning cloth to retract away from the blanket cylinder. Additionally, the bladder may be deflated between advances of the cleaning cloth.

It is understood that a bladder need not be mounted on a manifold, but instead may be a self-contained unit that affixes to a frame and an air supply. In this way, the use of a manifold is not necessary. In another embodiment, the function fulfilled by inflating the bladder is taken by mechanical means. This mechanical means engages the bladder and cloth to the blanket cylinder in much the same way air pressure does. The bladder in this embodiment would be positioned to have some gap between the bladder and whatever supported it, in order to take advantage of the desirable characteristics of the bladder.

It is also understood that the above description is only representative of illustrative examples of embodiments and implementations. For the reader's convenience, the above description has focused on a representative sample of all possible embodiments, a sample that teaches the principles of the invention. Other embodiments may result from a different combination of portions of different embodiments. The description has not attempted to exhaustively enumerate all possible variations.

Alternate embodiments may not have been presented for a specific portion of the invention. Some alternate embodiments may result from a different combination of described portions, or other undescribed alternate embodiments may be available for a portion. This is not to be considered a disclaimer of those alternate embodiments. It is recognized that many of those undescribed embodiments are within the literal scope of the following claims, and others are equivalent.

What is claimed is:

1. An bladder for bringing a cleaning cloth into contact with a blanket cylinder and the bladder comprising:
a central portion having a surface parallel to the blanket cylinder and elevated with respect to the bladder; and
a portion adjacent to the central portion that causes the surface of the central portion to make the cleaning cloth contact the blanket cylinder in a consistent manner during a cleaning operation.

2. The bladder according to claim 1 wherein the bladder is inflatable.

3. The bladder according to claim 1 wherein the bladder has an arcuate portion adjacent to the central portion.

4. The bladder according to claim 1 wherein the bladder has a flat portion parallel to the blanket cylinder.

5. The bladder according to claim 1 wherein the bladder has a mounting portion for affixing the bladder to an inflation means.

6. The bladder according to claim 1 wherein the bladder is U-shaped.

7. A bladder for use in an apparatus for cleaning the blanket cylinder of a printing press, the bladder comprising:
a proximal end for providing constant contact to the blanket cylinder, while moving a cleaning fabric into contact with said blanket cylinder;
a distal end functioning as a base; and
a member, essentially vertical with respect to the proximal and distal ends, for creating a moment to hold the proximal end essentially constant during its contact with the blanket cylinder.

8. The system consistent with claim 7 wherein the bladder is inflated in order to contact the blanket cylinder.

9. The system consistent with claim 7 wherein the bladder is mechanically engaged to contact the blanket cylinder.

10. The system consistent with claim 7 wherein the cleaning cloth is saturated to functional equilibrium prior to engagement of the bladder.

11. The system consistent with claim 7 wherein the bladder is mounted on a manifold.

12. The system consistent with claim 11 wherein the manifold is substantially U-shaped.

13. A bladder for cleaning a blanket cylinder, the bladder comprising:
an elevated central portion for holding a cleaning cloth that is in consistent contact with the blanket cylinder when the bladder is inflated, regardless of variation in the inflation means;
a mounting portion having flanges to affix the bladder to a manifold via clamps secured thereto;
a flat portion adjacent to the mounting portions of the bladder; and
an arcuate portion connected to the flat portion and the central portion for raising the central portion to provide a consistent contact region between the inflated bladder and the blanket cylinder.

14. The bladder according to claim 13 wherein the bladder is constructed as a single unit.

15. The bladder according to claim 13 wherein the bladder is longitudinally symmetric with respect to the blanket cylinder.

16. The bladder according to claim 13 wherein the bladder is non-permeable.

17. The bladder according to claim 13 wherein the manifold is attached to a printing press.

18. The bladder according to claim 13 wherein the shape of the bladder minimizes the need for sealant between the bladder and the manifold.

19. The bladder according to claim 13 wherein the blanket cylinder is dried by air pressure.

20. The bladder according to claim 13 wherein the manifold is filled with air under pressure for bringing the cleaning means into contact with the bladder cylinder.

21. The bladder according to claim 13 wherein the manifold is filled with some fluid under pressure for bringing the cleaning means into contact with the blanket cylinder.

22. The bladder according to claim 13 wherein the cleaning means is a cleaning cloth.

23. The bladder according to claim 22 wherein the cleaning cloth is treated with a cleaning solvent, or solvents, as the bladder brings the cloth in contact with the blanket cylinder.

24. The cleaning cloth according to claim 23 wherein the cleaning cloth is removed from a cloth supply roll prior to passing over the bladder.
